(19) United States
(12) Patent Application Publication
(10) Pub. No.: US 2005/0177336 A1
(43) Pub. Date: Aug. 11, 2005

(54) Method for identifying object constellations using distance signals

(76) Inventors: Uwe Zimmermann, Ludwigsburg (DE); Achim Pruksch, Neudenau (DE); Werner Uhler, Bruchsal (DE)

Correspondence Address: KENYON & KENYON, ONE BROADWAY, NEW YORK, NY, 10004, US

(21) Appl. No.: 10/512,162

(22) PCT Filed: May 27, 2003
(86) PCT No.: PCT/DE03/01720

(30) Foreign Application Priority Data
Dec. 23, 2002 (DE) 102 60 855.5

(51) Int. Cl. G01C 19/00; G01C 17/00; G06F 15/00; G01C 9/00

(52) U.S. Cl. 702/150

(57) ABSTRACT

A method for the detection of object constellations in the light of distance signals from at least two sensors, wherein the distance signals of a plurality of the sensors are submitted to a pattern recognition by comparison to reference patterns which correspond to predefined model constellations.

### FIELD OF THE INVENTION

The present invention relates to a method for detecting object constellations, as well as a device for carrying out or performing this method.

### BACKGROUND INFORMATION

Motor vehicles are increasingly being equipped with sensors that resolve separation distances (spacing, clearing, gap), and they are situated, for example, in the region of the front bumper of the vehicle, and are used to locate obstacles ahead of the vehicle, such as preceding vehicles, and to determine their distances, and possibly their speeds relative to one's own vehicle. In this context, at least in the near-by region, the position of the object or objects should be recorded in a two-dimensional coordinate system.

Examples of applications for a sensor system of this kind are, for instance, collision warning or the so-called pre-crash sensing, in which the main point is, in the case of an imminent crash, to determine ahead of time the exact time and, if possible, also the exact location of the crash, so that security devices in the vehicle, such as air bags, belt pretensioners and the like may be configured already in preparation for the imminent collision. An additional example of an application is distance and speed regulation (ACC; adaptive cruise control). The near-range sensor system finds application, in this context, especially in operating modes which are characterized by relatively low speeds and high traffic density, as well as by high dynamics, such as in stop & go operations.

Pulsed 24 GHz radar sensors are frequently used as distance sensors, and they make possible a high distance resolution, but they generally do not have angular resolution. The two-dimensional position of the objects may then be determined by triangulation, by using at least two sensors. However, if there are two or more objects present, or if several reflection centers of the same object are present, ambiguities may arise in this connection with regard to assigning the distances measured by the various sensors to one another and to the objects. If, for example, two centers of reflection are recorded from two sensors, one obtains a total of four distance pairs, which characterize possible distances of the objects from each of the sensors. However, only two real objects correspond to these four distance pairs, whereas the remaining pairs are apparent objects, which have to be eliminated in retrospect by a plausibility evaluation.

German patent document no. 199 49 409 refers to a method for eliminating apparent objects with the aid of a tracking procedure. “Tracking” is understood to mean following objects (or apparent objects) over a longer period. Since the distance measurements are repeated periodically, usually at a cycle period of the order of magnitude of a few milliseconds, one may assume that the distances, relative speeds and accelerations of the objects differ only a little from measurement to measurement, and that, for example, the measured distance changes are consistent with the measured relative speeds. On this premise, it is possible to rerecord the objects recorded during one measurement in the subsequent measurements, so that one may, so to speak, follow the track of each object.

In available methods for detecting object constellations, the objects and apparent objects are tracked individually. Therefore, especially if several objects or centers of reflection are present, these methods require great calculating effort, and correspondingly, have a great memory requirement and a long computing time or a large computing capacity. For removing ambiguities and for exact identification of the object constellation, it is also understood that one may use three or more separation distance-resolving sensors, which, however, further increases the computing expenditure.

### SUMMARY OF THE INVENTION

Compared to that, the exemplary method having the features of the subject matter described herein offers the advantage that, for a given number of sensors and a given number of centers of reflection, the computing effort and memory requirement for a sufficiently precise and detailed detection of the object constellations may be considerably reduced, and that particularly the problems connected with the appearance of apparent objects may be largely avoided.

The exemplary embodiment and/or exemplary method of the present invention concerns the fact that not every single object or center of reflection are followed independently of the rest, but instead, from the totality of the distances, measured with the various sensors, of the various centers of reflection characteristic patterns are detected, which correlate with known patterns of typical model constellations.

By comparison of the recorded patterns to reference patterns that correspond to the various model constellations, one may then decide to which model constellation the current constellation bears the greatest resemblance, and from the constellation characterized in this manner one may then directly derive the relevant data for the application purpose.

In this context, it is especially advantageous that one may now do the tracking by tracking the pattern as a whole. Since this pattern may generally be described by a set of parameters which is clearly smaller than the totality of the coordinates of all objects and apparent objects, there comes about a saving in memory requirement and computing time.

As with the available methods, for each sensor a distance list is set up, in which the distances of centers of reflection measured by this sensor are ordered by increasing distance. It has been shown by a statistical evaluation of distance lists, obtained in this manner under conditions close to actual practice, that distances obtained using several sensors may generally be grouped into clusters, which may be assigned to the same object or to several objects that are located at the same distance in front of one's own vehicle. When using radar sensors, for example, the relatively starkly jagged rear end of a truck generates a plurality of centers of reflection which have similar distances for all the sensors, and which may all be assigned to the same object, namely the truck. Naturally, the smallest measured distances are especially relevant for the evaluation of the distance information. In one particularly expedient specific embodiment, therefore, for each cluster, in each case only the smallest distance value in the distance list of each sensor is evaluated, and only these distance values are put in as the basis for further pattern recognition.

Since the individual sensors are situated offset by a certain distance to one another in the direction transverse to the longitudinal axis of the vehicle, the so-called basic width, the smallest distance values within each cluster form a characteristic pattern which makes it possible to draw conclusions regarding the object constellation, i.e. the spatial position of the object(s) belonging to this cluster relative to each other and to one's own vehicle. If, for example, a located object is at a slight distance from the middle of one's own vehicle, the sensors lying closer to the longitudinal center axis will measure for this object a smaller distance than the sensors lying further out at the vehicle's edge. Compared to that, if two located objects are situated at the same distance left and right next to the center axis of one's own vehicle, such as is the case, for instance, when driving into a parking gap, the sensors lying closer to the vehicle's edges will measure smaller distance values than the sensors lying closer to the middle. In one particularly advantageous specific embodiment of the method, if at least three sensors that resolve distance are used, one is able to decide, based on these characteristics, which object constellation just happens to be present at this point.

It is of advantage if the pattern, formed by the shortest distances by n (≦=3) sensors, is characterized by the n coefficients of a polynomial of the (n−1)th degree. In a Cartesion coordinate system, if x denotes the coordinate in the direction parallel to the vehicle's longitudinal axis, and y the coordinate transverse to the vehicle's longitudinal axis, then the polynomial has the form x=f(y). The graph of this polynomial then describes approximately the pattern of the backward boundary of one or more objects that belong to the same cluster. In the case of three sensors, the graph of this polynomial is a parabola. The minimum of the parabola gives with good approximation the smallest object distance, and the y coordinate of this minimum gives with good approximation the transverse offset of this object, or rather, of the point which has the shortest distance to one's own vehicle. In the nature of things, these variables are particularly suitable for making an estimate of the location and the point in time of a prospective crash.

In addition, from a polynomial of the form x=ay²+by+c, one may directly derive further important information on the object constellation from the coefficients a, b and c. For example, based on the interrelationships explained above, a positive sign of the coefficient points out that the respective cluster describes a located object having little transverse offset. At fixed coefficient c, the smaller a is, the more extended is the object. The condition a=0 characterizes a very wide object, such as the rear end of a truck, which is at approximately the same distance from all the sensors of the vehicle. A negative coefficient a at close to vanishing coefficient b lets one know that the cluster represents two objects which lie symmetrically about the vehicle's longitudinal axis. In general, coefficient b (more generally, the coefficients of odd exponents of y) permits making a statement concerning the symmetry of the object constellation; b=0 means complete symmetry, and in the case of b≠0, the sign of b says to which side the center of gravity of the object constellation is offset with respect to the vehicle's longitudinal axis.

It is obvious that, for physically possible situations, the coefficients of the polynomial must lie in each case within certain value ranges, the possible value range of one coefficient being able to be a function of the current value of another coefficient. If, for instance, coefficient c has a relatively large value, the object is at a correspondingly great distance from one's own vehicle, and the differences in the measured object distances, conditioned by the transverse offset of the sensors about basic width B, are correspondingly small, so that only a small value range comes into consideration for coefficient a. The admissible value ranges or combinations of values and value ranges may be ascertained by investigating typical model constellations. This makes possible a plausibility test of the results obtained for each cluster, and, at the same time, a classification of the object constellation according to typical constellations. In this way, possible errors in the assignment of the values found in the distance lists to the individual clusters may quickly be recognized and corrected, if necessary.

By tracking the pattern detected for each cluster, i.e. the set of coefficients a, b and c, the accuracy and reliability of the recognition is further increased, and it is also possible to supplement missing measured values, caused by temporary disturbances in the measuring process, in a meaningful way.

Using the exemplary method according to the present invention, since it is possible efficiently to evaluate even relatively voluminous distance lists, corresponding to a very large number of centers of reflection, using a justifiable computing effort, the sensitivity range of the sensors and particularly the position finding angle range of the sensors may be widened without a problem, so that even objects in the next roadway may be taken up into the sensing system in greater volume. This makes possible, for example, the early detection of situations in which a vehicle from the next lane suddenly swings in, in front of one's own vehicle. Depending on the purpose of the application, it is also possible to mount the entire sensor system or additional sensor systems on the rear of the vehicle or at the side of the vehicle, and to make backwards alignments or ones towards the side.

The use of at least three sensors has the advantage that the differentiation between a single object and two symmetrically situated objects is possible even in static situations, i.e. based on the results of a single measuring cycle, without having to evaluate the movement of the objects within the scope of the tracking procedure.

### BRIEF DESCRIPTION OF THE DRAWINGS

FIG. 1 shows a schematic layout of a vehicle equipped with three sensors that resolve distances, and two preceding vehicles whose constellation is to be detected by the evaluation of distance measurements.

FIG. 2 shows a graphic representation of the entries into distance lists for the three sensors, for the system shown in FIG. 1.

FIG. 3 shows a graphic representation of the distance values selected from the diagram as in FIG. 2 for further evaluation, and the characterization of object constellations by parabolas.

FIG. 4 shows an example of a different model constellation than that of FIG. 5.

FIG. 5 shows an example of a different model constellation than that of FIG. 4.

FIG. 6 shows a graphic representation for the characterization of the model constellation by parabolas.

FIG. 7 shows a graphic representation for the characterization of another model constellation by parabolas.

FIGS. 8(a), 8(b) and 8(c) show examples of admissible value ranges of the coefficients of the parabolic function for different model constellations of an individual object.

FIGS. 9(a), 9(b) and 9(c) show examples of admissible value ranges of the coefficients of the parabolic function for model constellations having two symmetrically situated objects.

FIG. 10 shows a flow chart illustrating the course of the exemplary method.

### DETAILED DESCRIPTION

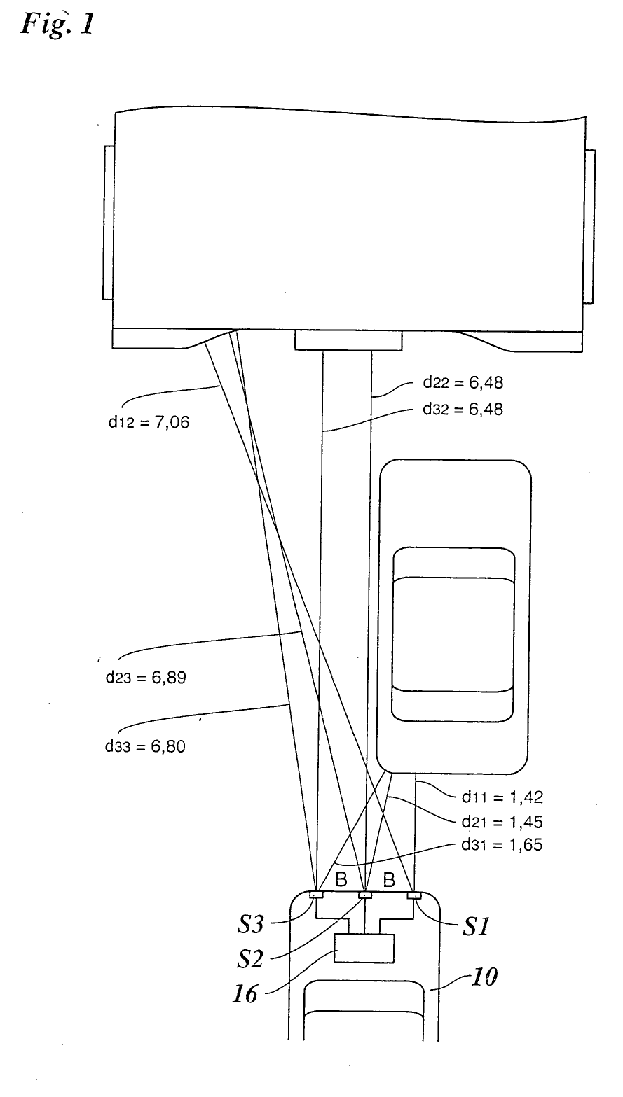

In FIG. 1, at the bottom edge of the drawing, the front end of a motor vehicle 10 is shown, in which three sensors S1, S2 and S3, that resolve distances, are positioned at the same height in the region of the front bumper. In the example shown, the sensors are situated symmetrically to the vehicle's longitudinal axis. The basic width is denoted by B, and that is the lateral distance from sensor to sensor. With regard to sensors S1, S2 and S3, for instance, pulsed 24 GHz radar sensors are involved, which each have a position-finding angle range of 140°. As an example, it may be assumed that the position-finding angle ranges lie in each case symmetrically to a straight line that goes through the middle of the respective sensor and is parallel to the vehicle's longitudinal axis. However, the position-finding angle ranges of the outer sensors S1 and S3 may also optionally, for example, be directed outwards. The position-finding depth of sensors S1, S2 and S3 amounts to 7 m, for example.

In front of vehicle 10 are shown, as objects to be recognized, a passenger car 12 (not marked) and a truck 14 (not marked). Truck 14, in particular, has a greatly jagged rear end, and therefore forms several centers of reflection for each of sensors S2 and S3. The radar rays from sensor S1 to the centers of reflection of passenger car 12 and truck 14 and back to sensor S1 are shown as straight lines, and the appertaining distances that are measured by sensor S1 are shown as d₁₁ and d₁₂. Correspondingly, the distances between sensor S2 and the appertaining centers of reflection are given as d₂₁, d₂₂ and d₂₃, and the distances between sensor S3 and the appertaining centers of reflection are designated as d₃₁, d₃₂ and d₃₃. In the example sown, sensor S1 receives only two reflection signals, one from passenger car 12 and one from truck 14, since a part of truck 14 is shaded by passenger car 12. Numerical examples given for the distance values are stated in m in FIG. 1.

The distance values measured by sensors S1, S2 and S3 are evaluated in an evaluation unit 16 on board of vehicle 10, and the results are made available to additional system components of this motor vehicle, such as a pre-crash system, a distance and speed regulation system (ACC) and the like.

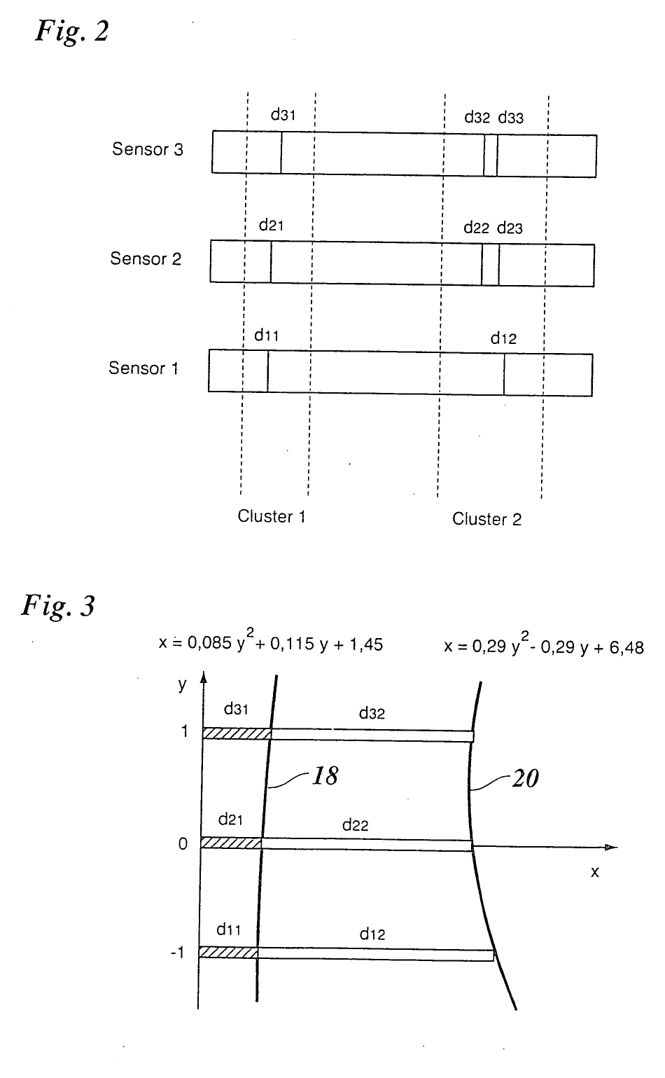

Evaluation unit 16 first sets up a distance list for each sensor S1, S2 and S3, in which the measured distances are ordered by increasing value. This is shown graphically in FIG. 2. One can see that the distance values d₁₁, d₂₁, d₃₁ differ only slightly from one another (in any case, less than double the basic width B), and may be combined to a “cluster 1”, which represents a first object, namely passenger car 12. Correspondingly, the remaining five distance values d₁₂, d₂₂₁, d₃₂ and d₃₃ may be combined to a “cluster 2”, which represents truck 14.

Now, the shortest distance value is selected from each of the two clusters respectively for each of sensors S1, S2 and S3, for further evaluation. For cluster 1, these are the distance values d₁₁, d₂₁ and d₃₁, and for cluster 2 they are the values d₁₂, d₂₂ and d₃₂. Distance values d₂₃ and d₃₃ are ignored.

In FIG. 3, the distance values drawn upon for the evaluation are plotted on a two-dimensional coordinate system, whose x axis is equivalent to the longitudinal axis of the vehicle, and whose y axis points in the transverse direction of the vehicle (to the left, with respect to the direction of travel). The y coordinate is here measured in units of basic distance B, so that sensor S1 has the coordinate y=−1 and sensor S3 has the coordinate y=+1.

From the three distance values of each cluster, the coefficients a, b and c of a polynomial function of the form x=ay²+by+c are now calculated.
a=(d₁+d₂−2d₂)/2
b=(d₃−d₁)/2
c=d₂

In these equations, in each case in the distance values, the second subscript (the ordinal number in the distance list) is left off.

For the polygonometric function for cluster 1 one thus obtains a parabola 18, and for cluster 2 a parabola 20. These parabolas or their appertaining coefficients now form a pattern which permits classifying the object constellations represented by the clusters.

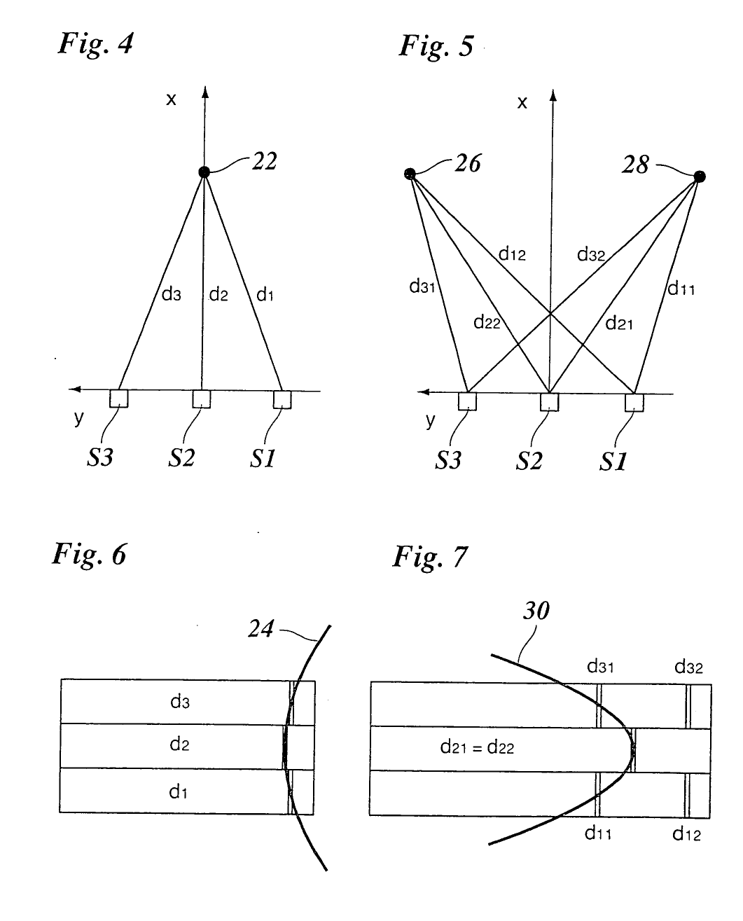

FIG. 4 shows a model constellation in the form of a located individual object 22, which lies centrically ahead of vehicle 10 at a certain distance (y=0). The appertaining object distances d₁, d₂ and d₃ and parabola 24 resulting from them are shown in FIG. 6 in an analogous form to FIG. 3. Since in this constellation distances d₁ and d₃ are greater than d₂, coefficient a has a positive value for parabola 24. If object 22 were at a greater distance from the sensors, the differences of the distances would be shorter, and the parabola would be flatter, i.e. coefficient a would be smaller in absolute value. The same effect would also appear if object 22 extended in the y direction.

FIG. 5 shows another model constellation in the form of two located objects 26, 28, which lie symmetrically to the longitudinal axis that goes through the middle of vehicle 10. In this case, the shortest distances d₁₁, d₂₁, measured by sensors S1 and S3 are shorter than distances d₂₁=d₂₂ measured by middle sensor S2, and as a result, the appertaining parabola 30 in FIG. 7 has a negative coefficient a. In practice, the model constellation shown in FIGS. 5 and 7 is approximately equivalent to the case in which objects 26 and 28 border on a parking gap into which vehicle 7 is being driven.

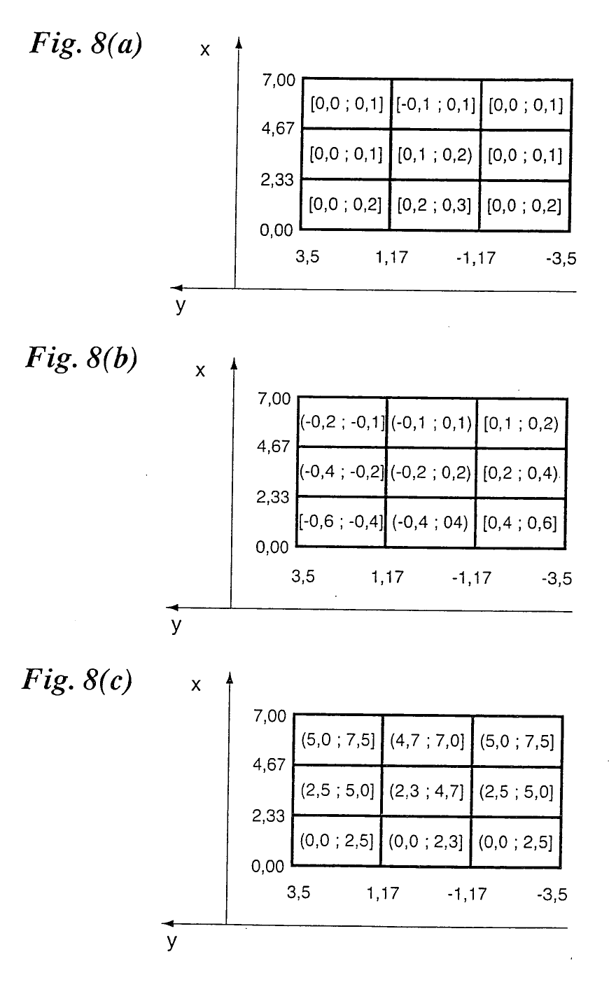

In FIG. 8(a), in a table consisting of three rows and three columns, the possible value ranges for coefficient a for model constellations are entered in which, similar to FIG. 5, only a single located object is present which, however, in this instance does not necessarily lie on the longitudinal center axis of vehicle 10, but may have a transverse offset of y=−3.5 m to y=3.5 m with respect to the longitudinal center axis of the vehicle. The distance of this object may amount to between 0 and 7 m. The region for transverse offset y as well as the distance range from 0 to 7 m are in each case divided up into three equal intervals, which are represented by the three rows and the three columns of the table in FIG. 8(a).

FIGS. 8(b) and 8(c), in corresponding fashion, give the value ranges of coefficients b and c for the same model constellations. The numerical values of the limits of the coefficients' value ranges are only to be understood as rough indications, and have to be calculated in the individual case for the respective basic width B between the sensors. The boundaries of the value range, for example, in the left upper field in FIG. 8(a) (0.0≦a≦0.1) are based on the assumption that a point-shaped object may occupy every position within the rectangle that is defined by the y interval [1.17;3.5] and the x interval [4.67;7.0]. The corresponding applies to the value ranges in the remaining fields in FIGS. 8(a), (b) and (c).

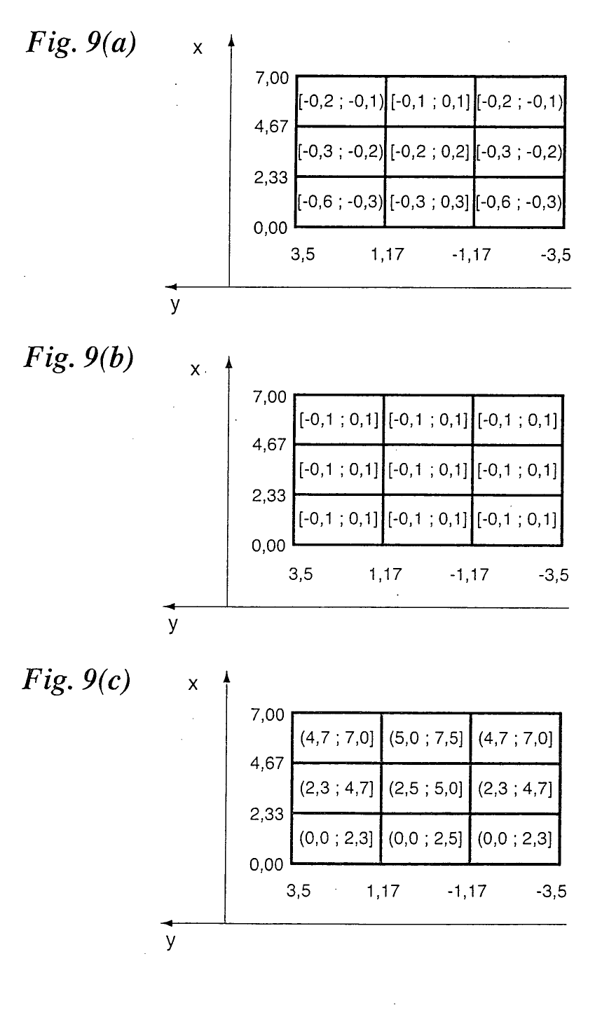

In FIGS. 9(a), (b) and (c) the corresponding value ranges of coefficients a, b and c are given for model constellations in which, similarly to FIG. 5, two located objects lie symmetrically with respect to the longitudinal center axis of the vehicle. If one of these objects lies in the interval [−3.5; −1.17], correspondingly the other object lies in the interval [1.17; 3.5]. For this reason, the entries in the right column of FIGS. 9(a), (b) and (c) are in each case identical to those in the left column. The middle columns refer in each case to constellations in which the two objects lie symmetrically to the longitudinal middle axis of vehicle 10 in the same y interval [−1.17; +1.17].

If, in a current measuring cycle, the coefficients a, b and c have been determined for a given cluster, it is checked, in the light of the tables according to FIGS. 8 and 9, whether a model constellation can be found for which all three coefficients lie in the value ranges admissible for it. If this condition is satisfied, it may be assumed that the three distance values represent a constellation that is physically possible. If no such model constellation can be found, the set of distance values and the appertaining set of coefficients are discarded as being physically impossible. A possible reason for this may, besides measuring errors and interference influences, also be that one of the distance values was assigned to the wrong cluster. In general, it will turn out already upon subdivision of the clusters that the assignment of a special distance value is doubtful. In this case, then, this measured value is assigned to the other cluster that comes into consideration, and the evaluation is repeated.

For constellations in which the coefficients lie in the value ranges in the middle column in FIGS. 8 and 9, the differentiation between a single object (FIG. 8) and two symmetrically situated objects (FIG. 9) is first of all less relevant because the distance between these objects is then less than 2.34 m, and consequently is of the same order of magnitude as the width of vehicle 10. Still, this differentiation may prove meaningful, for instance, if it is shown in response to the subsequent tracking that the two symmetrically situated objects are moving apart in the positive or negative y direction, or if it is shown that, upon a closer approach to the objects and corresponding increased measurement accuracy, the gap between the two objects is nevertheless so big that one's own vehicle will fit into it.

In the method described here, since, right from the beginning, one works only with the shortest distance values within each cluster, and in addition to this all constellations are discarded as being implausible in which the calculated coefficients a, b and c do not all lie within the admissible value ranges, complications, which could come about by the possible appearance of apparent objects, are avoided from the start.

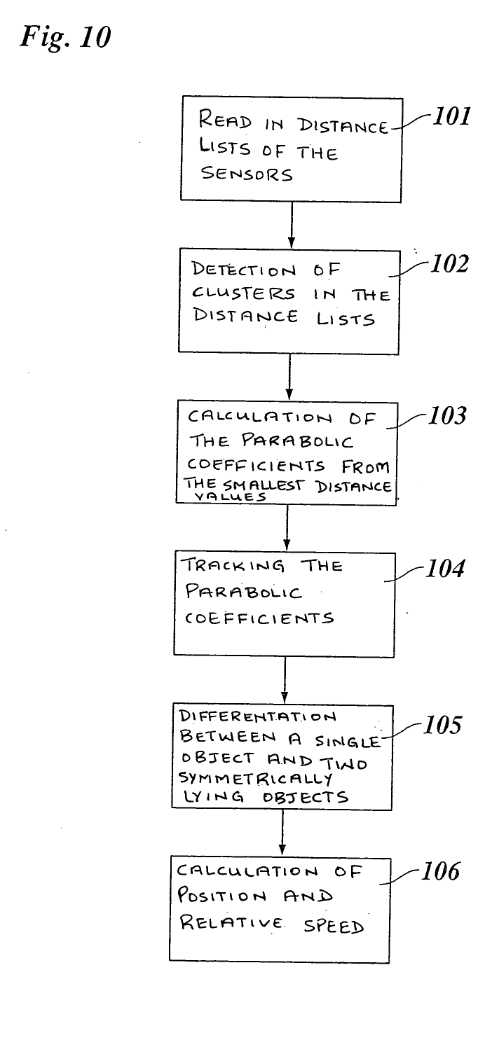

In FIG. 10, the sequence of the method is shown once more in the form of a flow chart.

In step 101 the distance lists of sensors S1, S2 and S3 are read into evaluation unit 16, as shown in FIG. 2. Subsequently, in step 102 the distance values in the distance lists of all the sensors are combined into clusters, as is also illustrated in FIG. 2. After that, in step 103, the coefficients a, b and c of the parabolic function are calculated from the shortest distance values for each cluster and each sensor. This set of coefficients then forms the pattern which is characterized by the respective object constellation. In step 104 the tracking method for the parabola coefficients is carried out. That means, the coefficient sets a, b, c are compared cluster by cluster to corresponding sets from the preceding measuring cycle or the preceding measuring cycles, and, in the light of the similarity or difference of the coefficients, and their derivations with respect to time, and in the light of the consistency between the derivations with respect to time and the coefficients it is decided whether the object constellation from the current cycle may be identified with one of the object constellations from the previous cycle. Thus the change with time of the object constellations may be followed in this manner.

Then, in step 105, in the light of the tables illustrated in FIGS. 8 and 9, it is checked whether the coefficients lie within admissible limits, and object constellations having inadmissible coefficients are discarded. In this plausibility test or filtering, one may optionally also revert to recognitions resulting from preceding tracking step 104. It is likewise possible to supplement missing measuring results by extrapolating results of the preceding tracking steps. In order to increase the robustness of the method, it is optionally also possible, in addition to the value range tables according to FIGS. 8 and 9, in which one assumes in each case that, within each cluster at least one measured value is present for each sensor, to set up and evaluate corresponding tables for situations in which, within one cluster, only measured values for two of the three sensors are present.

Finally, in step 106, the positions and relative speeds of the respective objects are calculated for the clusters or object constellations which were left over after checking done in step 105. In the case of single objects, the x and y coordinates of the minimum of the parabola are calculated for the position calculation. In this way, one obtains relatively accurate information on the minimal distance of the object and on the y coordinate of the location at which, in response to further decrease in the separation distance, prospectively the crash would take place. By differentiation with respect to time of these variables, the relative speeds in the x and y direction can also be determined. In the case of two symmetrically situated objects, between which there is a gap having a width that is smaller than the vehicle's width, the minimal object separation distance may be calculated by evaluating the parabolic function for the y values corresponding to the left and right vehicle wheels. In the light of the amount of the negative coefficient a it can also be decided in conjunction with coefficient c whether the gap between the two objects is big enough for one's own vehicle. This will, for example, be the case if the current object constellation can be identified with one of the model constellations in the left column or the right column in FIG. 9(a).

1-11. (canceled)

12. A method for detecting an object constellation based on distance signals of sensors, the method comprising:
providing distance signals of at least two sensors; and
submitting the distance signals of the sensors to a pattern recognition by comparison to reference patterns which correspond to a predefined model constellation, for detecting the object constellation based on the distance signals.

13. The method of claim 12, wherein the distance values measured by the sensors are combined into clusters within which distance values of the distance signals differ only a little, and only a shortest distance value is evaluated within each of the clusters for each of the sensors.

14. The method of claim 13, wherein for each of the clusters, coefficients of a polynomial function, which approximates a pattern of a boundary of the object on a side facing the sensors, are calculated from evaluated distance values.

15. The method of claim 14, wherein the polynomial function is a parabolic function, and coordinates of a minimum of the parabola are calculated.

16. The method of claim 15, wherein for each set of coefficients it is determined whether the coefficients lie within predetermined value ranges calculated with the model constellation.

17. The method of claim 14, wherein for each set of coefficients it is determined whether the coefficients lie within predetermined value ranges calculated with the model constellation.

18. The method of claim 13, wherein in each case the distance values are evaluated that were measured by at least three sensors.

19. The method of claim 18, wherein it is determined based on the calculated coefficients whether the object constellation corresponds to one single object or to two objects which lie symmetrically about an axis which lies at right angles to a straight line connecting the sensors and goes through a center of a sensor system of the sensors.

20. The method of claim 14, wherein it is determined based on the calculated coefficients whether the object constellation corresponds to one single object or to two objects which lie symmetrically about an axis which lies at right angles to a straight line connecting the sensors and goes through a center of a sensor system of the sensors.

21. The method of claim 13, wherein in a tracking procedure, the object constellations represented by their patterns are tracked.

22. A device for detecting object constellations based on distance signals of at least two sensors, comprising:
an evaluation unit which submits the distance signals of the sensors to a pattern recognition by comparison to stored reference patterns which correspond to predefined model constellations.

23. The device of claim 22, wherein the sensors include at least three sensors.

24. The device of claim 23, wherein the sensors are positioned in the front region of a motor vehicle.

25. The device of claim 22, wherein the sensors are positioned in a front region of a motor vehicle.
